(19) United States
(12) Patent Application Publication
(10) Pub. No.: US 2006/0162592 A1
(43) Pub. Date: Jul. 27, 2006

(54) Gravure printing unit for printing a printing material web in a printing press

(76) Inventor: Roger Oberholzer, St. Gallen (CH)

Correspondence Address: LERNER GREENBERG STEMER LLP, P O BOX 2480, HOLLYWOOD, FL, 33022-2480, US

(21) Appl. No.: 11/338,245

(22) Filed: Jan. 24, 2006

(30) Foreign Application Priority Data
Jan. 24, 2005 (DE) 10 2005 003 206.0
Sep. 16, 2005 (DE) 10 2005 044 516.0

(51) Int. Cl. B41F 9/00

(52) U.S. Cl. 101/153

(57) ABSTRACT

A gravure printing unit for printing a printing material web in a printing press is particularly suited for a label printing press. The unit has at least one gravure cylinder, one ink applicator device, one impression roller and at least one connecting element for releasable accommodation on at least one connecting platform of the printing press and for producing a releasable operative connection having a separate drive for the gravure cylinder. The gravure cylinder and the ink applicator device can be separated from the at least one connecting platform, while the impression roller remains in the printing press.

### BACKGROUND OF THE INVENTION

### Field of the Invention

The invention lies in the printing technology field. More specifically, the invention relates to a gravure printing unit for printing a printing material web in a printing press, having at least one gravure cylinder, one ink applicator device, and one impression roller.

In printing presses for printing labels, in particular self-adhesive labels, great flexibility or variability is desired increasingly, in order for it to be possible to carry out as many different print jobs as possible, in particular with production of special optical effects by the printed image or the printed text. In order to produce labels, printing presses are used particularly frequently which process a narrow web of a printing material and have a number of connecting platforms or interfaces, on which in each case one functional unit or one process module can be accommodated releasably for printing with a defined printing process. For example, one exemplary embodiment of a printing press of the generic type is described in the U.S. Pat. No. 4,384,522.

There, the individual functional units can operate with differing printing processes.

Commonly assigned U.S. Pat. No. 6,019,046 (German published patent application DE 195 13 536 A1) and U.S. Pat. No. 5,697,297 (Int'l PCT publication WO 95/29813) discribe printing presses which have a plurality of printing units of inline construction and permit the releasable accommodation of a number of functional units or process modules on a number of connecting platforms. Inter alia, the functional units can comprise printing units or parts of printing units in cassettes or attachments which operate according to a letterpress process, a flexographic printing process, a screenprinting process, an offset printing process, a gravure printing process or an inkjet printing process. Moreover, functional units (processing units) are provided which permit mechanical processing steps on the printing material, for example embossing, trimming (perforating, punching) or turning. Printing presses of this type which can operate with a plurality of different printing processes are also known as combination printing presses or hybrid printing machines, which are generic terms in this technical field.

One configuration of a gravure printing unit that is used frequently, as is also used in the form of a functional unit for a printing press which is equipped with connecting platforms for changing purposes, is shown, for example, in German patent DE 42 42 582 C2. The circumferential surface of a gravure printing form cylinder, also called an gravure cylinder further below, dips at least partially into an ink pan or ink trough which is filled with gravure printing ink and is arranged below the gravure cylinder. When the gravure printing cylinder is rotated about its axis of symmetry, the depressions in the circumferential surface which pass the trough are filled with gravure printing ink. Excess ink is wiped off by at least one doctor which is set against the circumferential surface. In a press nip which lies in the upper angular sector of the gravure printing form cylinder, the gravure printing ink is transferred onto a printing material which is pressed onto the inked circumferential surface of the gravure printing form cylinder by means of a impression roller, often also called an impression roller. If a gravure printing unit of this type is configured as a process module, in particular in the form of an attachment or a cassette, for a printing press having connecting platforms, the result in a web processing printing press is the practical disadvantage which is not to be underestimated that the printing material web has to be threaded through the gravure printing unit along its path. In other words, the paths of the web through the printing press differ from one another with and without the gravure printing press. The change from a gravure printing unit to a printing unit which operates with another printing process, or vice versa, is therefore associated with a corresponding changeover time.

Furthermore, German published patent application DE 41 39 343 A1 describes a proof or sample printing press which has an impression roller cylinder that can be exchanged. Further exchangeable cylinders which are mounted on movable carriages, optionally a gravure printing cylinder or a flexographic printing cylinder which interacts with an anilox cylinder, can be set against the impression roller cylinder. The exchangeable cylinders are driven by the impression roller cylinder by a frictional connection or by a form-fitting gearwheel connection.

It is likewise to be noted at this point that, if gravure printing inks are used which contain solvents, measures have to be taken for protection against explosions and for environmentally friendly disposal. An insulated printing zone (encapsulation, protective covering) is provided, from the area of risk of which, in particular, open electrical components are removed. The solvent fumes are often also extracted by suction. If solvent-free, UV light-curable gravure printing inks are used as an alternative to gravure printing inks which contain solvents, a corresponding selection of materials in the gravure printing unit and adapted engraving of the gravure printing cylinder are required. A device for illuminating with UV light is also arranged behind the press nip of the gravure printing unit, typically directly behind the latter, and optionally integrated with the gravure printing unit.

### SUMMARY OF THE INVENTION

It is accordingly an object of the invention to provide a gravure printing unit for printing a material web in a printing machine which overcomes the above-mentioned disadvantages of the heretofore-known devices and methods of this general type and wherein the gravure printing unit permits rapid replacement by a printing unit which operates according to different printing process.

With the foregoing and other objects in view there is provided, in accordance with the invention, a gravure printing unit assembly for printing a printing material web in a printing press, comprising:

a gravure cylinder, an ink applicator device, and an impression roller together disposed to form a functional gravure printing unit;

at least one connecting element for releasably mounting said gravure printing unit on a connecting platform of the printing press and forming a releasable operative connection with a separate drive for said gravure cylinder, wherein said gravure cylinder and said ink applicator device are separable from said connecting platform, while said impression roller remains in the printing press.

In other words, the gravure printing unit according to the invention for printing a printing material web in a printing press, has at least one gravure cylinder (used in this text as a short form for “gravure printing form cylinder”), one ink applicator device and one impression roller. The unit further has at least one connecting element for releasable accommodation on at least one connecting platform of the printing press and for producing a releasable operative connection having a separate drive for the gravure cylinder, with the result that the gravure cylinder and the ink applicator device can be separated from the at least one connecting platform, the impression roller remaining in the printing press, that is to say, in other words, the gravure cylinder and the ink applicator device can be separated without separating the impression roller from the printing press.

Here, the separation or the closing of the connection can preferably be effected without the course of the printing material web through the printing press being changed and/or without the printing material web being severed. According to the invention, there can be a first number, in particular a plurality, of connecting elements which serve only for the releasable accommodation on at least one connecting platform of the printing press, and a second number, in particular one or a plurality, of connecting elements which serve both for the releasable accommodation on at least one connecting platform of the printing press and also for producing a releasable operative connection having a separate drive for the gravure cylinder.

The gravure cylinder can be configured in such a way that it can hold a gravure printing form, in particular in the form of a sleeve, or that its circumferential surface forms an engraved gravure printing form.

In one preferred embodiment, the gravure printing unit has at least two connecting elements, at least one first connecting element being adapted or configured for the releasable accommodation of the gravure cylinder on a first connecting platform of the printing press, and at least one second connecting element being adapted or configured for the releasable accommodation of the ink applicator device on a second connecting platform of the printing press. In other words, both the gravure cylinder and the ink applicator device can be separated from the printing press and attached to the printing press independently of one another. Here, the first and the second connecting platforms can be configured particularly advantageously so as to be movable relative to one another, in particular so as to be displaceable or pivotable. Adaptation to different gravure printing cylinder diameters (which are dependent on the format) is possible by a relative movement, in particular a lateral displacement, with respect to one another. The accessibility can be increased or reduced in accordance with the different operations (printing, cleaning, setting up).

Furthermore, the gravure printing unit according to the invention can advantageously be configured in such a way that a connection is possible to at least one connecting platform which is configured so as to be displaceable in the substantially horizontal direction. In particular, the printing press can be a printing press of inline construction, that is to say having printing units which are arranged in the horizontal direction.

As an alternative or in addition to the measures which have already been described, the ink applicator device can be a chamber-type ink doctor which interacts with the gravure cylinder. The chamber-type ink doctor can be open, that is to say have an ink circuit with a continuous ink flow through the ink chamber, or closed. The chamber-type ink doctor can have a doctor which is thrown on at an acute angle to the rotational direction of the circumferential surface (negative doctor), so that work can be carried out with less pressure in order to set the doctor against the circumferential surface. The dependence of the print quality on the speed can be reduced. The consequence is advantageously less wear of the doctor. In an advantageous development, the gravure printing unit can have a pneumatic device for throwing the chamber-type ink doctor onto the gravure cylinder, in particular in the form of a number of pneumatic cylinders. The throwing-on pressure can be controlled or regulated as a function of the printing speed and/or the service life of the doctor (a measure for the wear of the doctor). As an alternative or in addition to this, the gravure printing unit can have a movement device for the lateral oscillation of the chamber-type ink doctor, that is to say substantially parallel to the rotational axis of the gravure cylinder.

Geometric alignment of the ink applicator device, in particular of the chamber-type ink doctor, with the gravure printing cylinder can preferably be carried out via eccentrics which can be adjusted individually on the drive side and operating side and independently of one another. The eccentrics can be configured as part of the connecting platform, that is to say integrated with the printing press. The throwing-on operation for printing of the ink applicator device, in particular of the chamber-type ink doctor, can be effected via at least two pneumatic cylinders which are connected in parallel as part of the ink applicator device.

Furthermore, it is advantageous for the gravure printing unit to have a separate drive apparatus for the gravure cylinder (individual drive, that is to say separate from the drives for producing further forms of movement in the printing press, such as the transport of printing material or the operation of other printing units or processing units). The separate drive apparatus is, in particular, independent of the drive of the impression roller in the gravure printing unit. In particular, the gravure printing unit can have a separate drive apparatus for the direct drive of the gravure cylinder. The operative connection can consist in that the shaft of the gravure cylinder is connected to the drive apparatus directly (with or without a gear mechanism or belt connected in between) and is set in rotation by said drive apparatus. The drive apparatus can be a servomotor. When the printing press is started up, it is possible for the gravure printing unit, in particular with a chamber-type ink doctor, to be started up without waste paper losses. Corrections to the format length are possible during printing due to the individual drive. It is preferred here that the separate drive apparatus is accommodated in the printing press and can be connected releasably to the gravure cylinder. In particular, at least one of the connecting elements of the gravure printing unit can represent not only a mechanical connection, but also a drive connection at the same time.

As an alternative or in addition to the features which have already been mentioned, the gravure printing unit can comprise an anti-ghosting device, in particular in the form of a third doctor or a roll which rolls on the circumferential surface of the gravure cylinder, with the result that eddying is produced in the flow in the reservoir of the ink applicator device. In one particular embodiment, the roll can be coated with rubber. The roll can have, in particular, suitable engraving for improved traction. Furthermore, the ink applicator device and/or the gravure cylinder of the gravure printing unit can have at least one heating element, with the result that the ink which is to be printed can be temperature-controlled. Heating is carried out to temperatures between 35 and 40 degrees Celsius for typical gravure printing inks. The flow properties of the gravure printing ink are influenced by the temperature control, with the result that the cells or depressions in the cover of the gravure printing cylinder can be filled in an improved manner. This can have the effect of a higher layer thickness and higher gloss in the printed image.

As an alternative or in addition to the features which have already been described, the impression roller can be accommodated in the printing press in a releasably connected manner. It is optionally necessary also to exchange the impression roller when changing from a first to a second printing process. A impression roller can also be used in a manner which is specific to the application, the circumferential surface of said impression roller having a defined hardness depending on the application.

The gravure printing unit according to the invention is preferably configured in such a way that the gravure cylinder and the impression roller are arranged in the printing press in such a way that their rotational axes lie substantially in a horizontal plane. This arrangement is particularly advantageous, inter alia, if cylinders having different diameters are to be used without changing the fundamental geometry of the gravure printing unit. Furthermore, this construction corresponds to advantageous arrangements of printing units which operate according to other printing processes, with the result that standardization is achieved. However, the gravure printing unit according to the invention can also be configured in such a way that the rotational axes of the gravure cylinder and the impression roller do not lie in a horizontal plane.

The gravure printing unit can also be configured so as to be usable for printing printing ink which can be cured by UV light (gravure printing ink which is free of solvents).

In one advantageous embodiment, the gravure printing unit according to the invention can have, furthermore, at least one additional deflection roller which is arranged above the impression roller in such a way that the wrap of the printing material web around the impression roller is reduced in comparison with operation without the at least one deflection roller. In this way, it is possible for the printing material web to follow a longer course after printing, for example for longer drying. This is advantageous, in particular, for production of a gloss effect, for example when varnishes are printed.

Also in conjunction with the concept of the invention is a gravure printing unit module having at least one gravure cylinder and one ink applicator device, which gravure printing unit module, in interaction with a impression roller which is accommodated in a printing press, realizes a gravure printing unit having features in accordance with this illustration. The gravure printing unit module can be configured, in particular, as a cassette, attachment or slide-in unit.

In conjunction with the concept of the invention is, furthermore, a printing press, suitable for printing a printing material web using a plurality of different printing processes, in particular a hybrid printing press or a combination printing press. The printing press according to the invention is distinguished by at least one gravure printing unit having features according to this representation. In particular, the printing press can be a narrow web printing press. In particular, the printing press can be configured to be of inline construction. In particular, the printing press can be a label printing press, an adhesive label printing press or a self-adhesive label printing press.

Other features which are considered as characteristic for the invention are set forth in the appended claims.

Although the invention is illustrated and described herein as embodied in a gravure printing unit for printing a printing material web in a printing press title, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of a first embodiment of the gravure printing unit according to the invention;

FIG. 2 shows a diagrammatic illustration of a second embodiment of the gravure printing unit according to the invention;

FIG. 3 shows a diagrammatic illustration of an embodiment of the gravure printing unit according to the invention, which embodiment has been developed advantageously;

FIG. 4 is a perspective view of one preferred embodiment of a gravure printing module of a gravure printing unit according to the invention; and

FIG. 5 is a perspective view of one preferred embodiment of the gravure printing unit according to the invention.

### DESCRIPTION OF THE PREFERRED EMBODIMENT

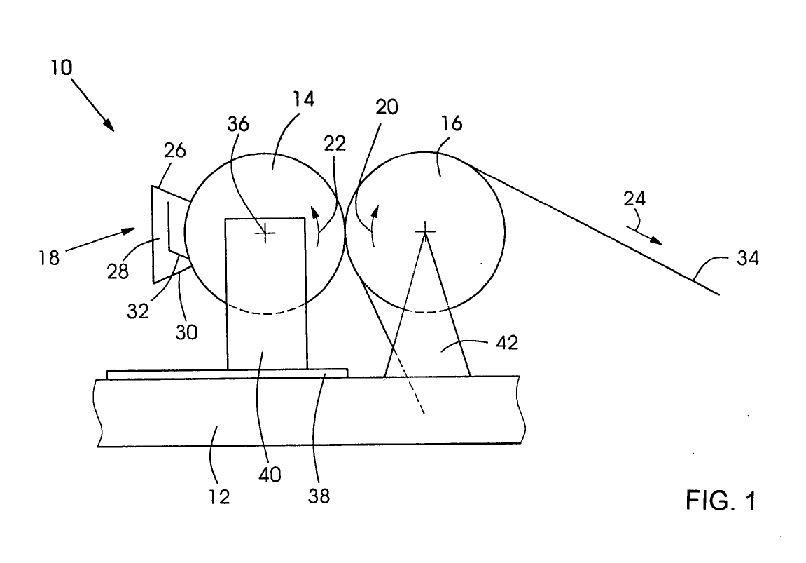

Referring now to the figures of the drawing in detail and first, particularly, to FIG. 1 thereof, there is shown diagrammatically a first embodiment of the gravure printing unit 10 according to the invention in a printing press 12, in particular a combination printing press or a hybrid printing press. This embodiment of the gravure printing press 10 has an gravure cylinder 14 (gravure printing form cylinder) which forms a press nip in interaction with an impression roller 16 (also referred to as a back-pressure or counter-pressure cylinder) and against which an ink applicator device 18 is set. The path of a printing material web 34 runs through the press nip. During operation of the gravure printing unit 10, the impression roller 16 rotates in the rotational direction 20 and the gravure cylinder 14 rotates in the rotational direction 22, and the printing material web moves along its path in the transport direction 24. In this embodiment, the rotational axes of both cylinders lie in a substantially horizontal plane. The ink applicator device 18 is configured as a chamber-type ink doctor 26 which is filled with gravure printing ink 28 and is arranged in the left-hand sector of the cover of the gravure cylinder 14; the symmetrical face of the chamber-type doctor 26, in particular, likewise lies substantially in the abovementioned horizontal plane. The doctor 30 of the chamber-type ink doctor 26 is a negative doctor. In this embodiment, the chamber-type ink doctor 26 has as anti-ghosting device 32 a third doctor which is configured as a positive doctor. The gravure cylinder 14 has a connecting element 36 which serves at the same time in this embodiment as a connection to the drive (lying concealed behind the gravure cylinder 14 in this view). The gravure cylinder 14 is accommodated releasably on a connecting platform 38 of the printing press 12, which connecting platform 38 has a bearing plate 40 which can be folded away. The impression roller 16 is accommodated on the printing press 12 by means of a impression roller bearing 42, independently of the gravure cylinder 14 and of the ink applicator device 18. In other words, while the impression roller 16 remains in the printing press 12, the further parts of the gravure printing unit 10 can be removed from the printing press 12, as they are configured such that they can be connected releasably to the printing press 12, with the result that it is not necessary for either the web to be severed or the path of the printing material web through the printing press 12 to be changed in order to remove the gravure printing unit 10.

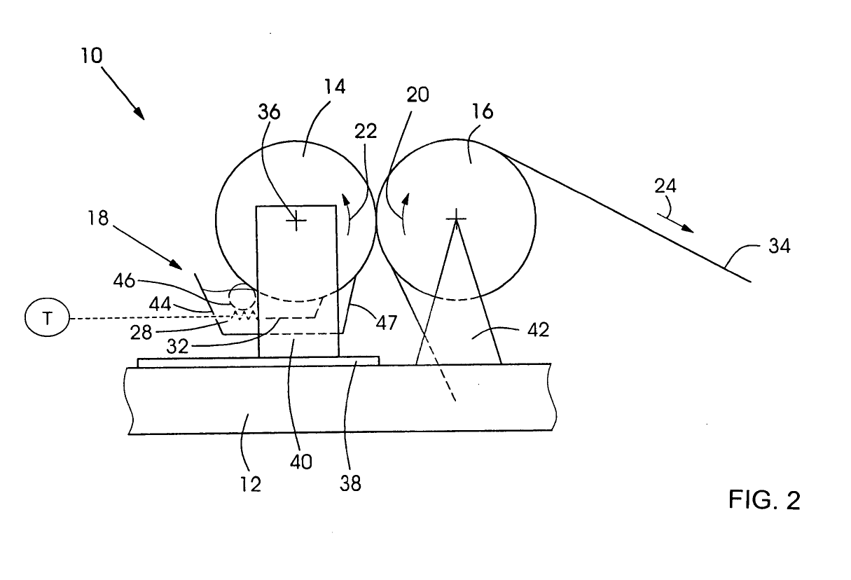

FIG. 2 is a diagrammatic illustration of a second embodiment of the gravure printing unit 10 according to the invention in a printing press 12, in particular a combination printing press or a hybrid printing press. The second embodiment of the gravure printing unit 10 has an gravure cylinder 14 (gravure printing form cylinder) which forms a press nip in interaction with a impression roller 16 and against which an ink applicator device 18 is set in the lower sector of the cover of the gravure cylinder 14. The path of a printing material web 34 runs through the press nip. During operation of the gravure printing unit 10, the impression roller 16 rotates in the rotational direction 20 and the gravure cylinder 14 rotates in the rotational direction 22, and the printing material web moves along its path in the transport direction 24. In this embodiment, the rotational axes of both cylinders lie in a substantially horizontal plane. The ink applicator device 18 is configured as an ink pan or ink trough 44 which is filled with gravure printing ink 28. The doctor 47 of the ink trough 44 is a positive doctor. In this embodiment, the ink applicator device 18 has as anti-ghosting device 32 a third doctor which is configured as a positive doctor. In addition, the ink applicator device comprises a pressing roll 46 for improving the inking of the gravure cylinder 14 and a heating element—connected to a temperature control T—for temperature-control of the ink. The heating element may instead or in addition be integrated in the gravure cylinder 14. The gravure cylinder 14 has a connecting element 36 which serves at the same time in this embodiment as a connection to the drive (lying concealed behind the gravure cylinder 14 in this view). The gravure cylinder 14 is accommodated releasably on a connecting platform 38 of the printing press 12, which connecting platform 38 has a bearing plate 40 which can be folded away. The impression roller 16 is accommodated on the printing press 12 by means of a impression roller bearing 42, independently of the gravure cylinder 14 and of the ink applicator device 18. In other words, while the impression roller 16 remains in the printing press 12, the further parts of the gravure printing unit 10 can also be removed from the printing press 12 in this embodiment, as they are configured such that they can be connected releasably to the printing press 12, with the result that it is not necessary for either the web to be severed or the path of the printing material web through the printing press 12 to be changed in order to remove the gravure printing unit 10.

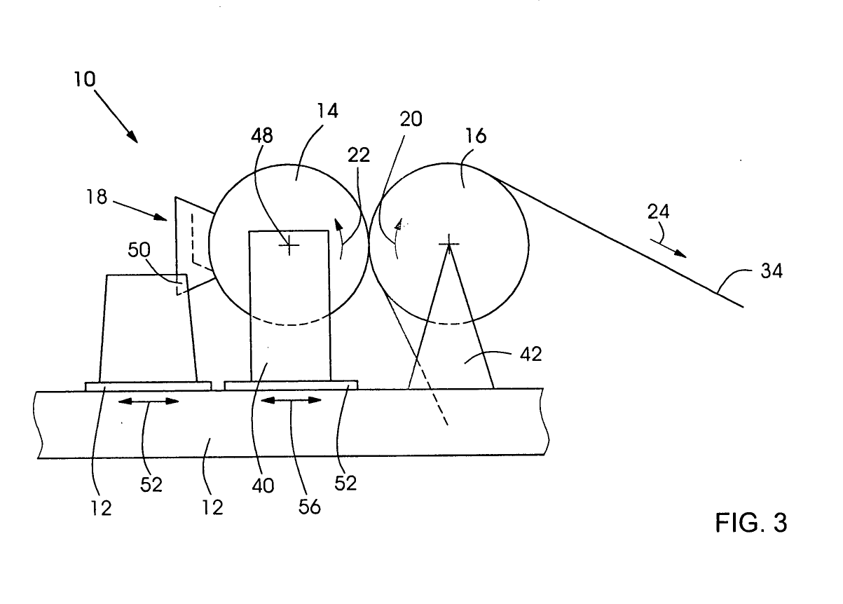

FIG. 3 relates diagrammatically to an advantageously developed embodiment of the gravure printing unit 10 according to the invention in a printing press 12, in particular a combination printing press or a hybrid printing press. In the same way as the other embodiments which have already been shown, this embodiment of the gravure printing unit 10 also has an gravure cylinder 14 (gravure printing form cylinder) which forms a press nip in interaction with a impression roller 16 and against which an ink applicator device 18, more precisely a chamber-type ink doctor, is set. As an alternative to the embodiment which is shown in FIG. 1, the chamber-type ink doctor can also be a chamber-type ink doctor which is open at the top, that is to say can comprise only a negatively thrown-on doctor on its underside in the lateral direction. The path of a printing material web 34 runs through the press nip. During operation of the gravure printing unit 10, the impression roller 16 rotates in the rotational direction 20 and the gravure cylinder 14 rotates in the rotational direction 22, and the printing material web moves along its path in the transport direction 24. In this embodiment, the rotational axes of both cylinders and the ink applicator device lie in a substantially horizontal plane. The gravure cylinder 14 has a first connecting element 48 which serves at the same time in this embodiment as a connection to the drive (lying concealed behind the gravure cylinder 14 in this view). The gravure cylinder 14 is accommodated releasably on a first connecting platform 50 of the printing press 12, which connecting platform 50 has a bearing plate 40 which can be folded away. The ink applicator device 18 has a second connecting element 50 which in this embodiment brings about at least a form-fitting connection with the printing press 12. The ink applicator device 18 is accommodated releasably on a second connecting platform 52 by means of a bearing plate. Both the first connecting platform 50 and the second connecting platform 54 are designed to execute a relative movement to the printing press 12: the first connecting platform 50 makes a first displacement possible in the direction 56, in such a way that the gravure cylinder 14 can be set against and away from the impression roller 16 in order to form the press nip. The second connecting platform 54 makes a second displacement possible in the direction 58, in such a way that the ink applicator device 18 can be set against and away from the cover of the gravure cylinder 14. In this way, an adjustment is possible in a particularly advantageous manner, inter alia, according to the format of the gravure cylinder (the diameter of the gravure cylinder). The impression roller 16 is accommodated on the printing press 12 in a fixed position by means of a impression roller bearing 42, independently of the gravure cylinder 14 and of the ink applicator device 18. In other words, while the impression roller 16 remains in the printing press 12, the further parts of the gravure printing unit 10 can be removed from the printing press 12, as they are configured such that they can be connected releasably to the printing press 12, with the result that it is not necessary for either the web to be severed or the path of the printing material web through the printing press 12 to be changed in order to remove the gravure printing unit 10.

The embodiment which is shown in FIG. 3 of the gravure printing unit 10 according to the invention comprises an additional deflection roller 78 which is arranged above the impression roller 16 at a spacing of 0.5 mm from the impression roller 16. In comparison with the embodiments shown in the other figures, the impression roller 16 is thus no longer wrapped around to the maximum extent.

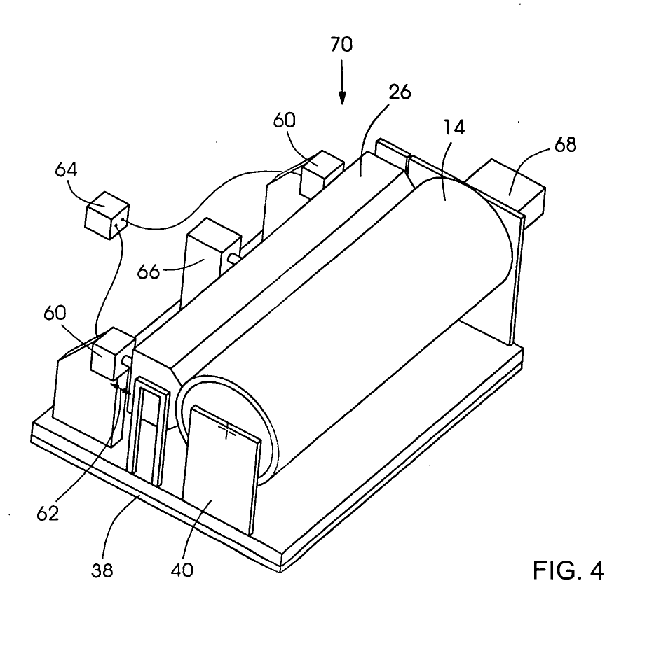

FIG. 4 shows a perspective diagrammatic view of one preferred embodiment of a gravure printing module 70 of a gravure printing unit 10 according to the invention. The gravure printing module 70 is suitable for being accommodated on a connecting platform 38 of a printing press 12 (not shown in this view), in particular of a combination printing press or a hybrid printing press. In interaction with a impression roller of the printing press, the gravure printing module 70 results in a gravure printing unit. The gravure printing module 70 comprises an gravure cylinder 14 which can be rotated by means of a separate drive 68. The gravure cylinder 14 can be accommodated on the printing press 12 by means of a cylinder mandrel or cylinder journal, via a bearing plate 40 of the connecting platform 38, which bearing plate 40 can be folded away. The gravure cylinder 14 can be a cylinder which accommodates a sleeve-shaped gravure printing form (shown here in FIG. 4) or a cylinder, the circumferential surface of which is engraved as a gravure printing form. The gravure cylinder 14 is assigned a chamber-type ink doctor 26 as ink applicator device 18. The chamber-type ink doctor 26 can be set against the gravure cylinder and away from the latter by means of a pneumatic throwing-on device 60, in particular in the form of two pneumatic cylinders, as obtained here. The throwing-on force can be controlled or regulated: the pneumatic throwing-on device 60 is connected to a control device 64. The control device can be part of the gravure printing module 70 or part of the printing press 12 (not shown here). Furthermore, the gravure printing module 70 comprises a device 66 for oscillating the chamber-type ink doctor 26. A particularly user-friendly embodiment is provided by a modular construction of the gravure printing unit 10.

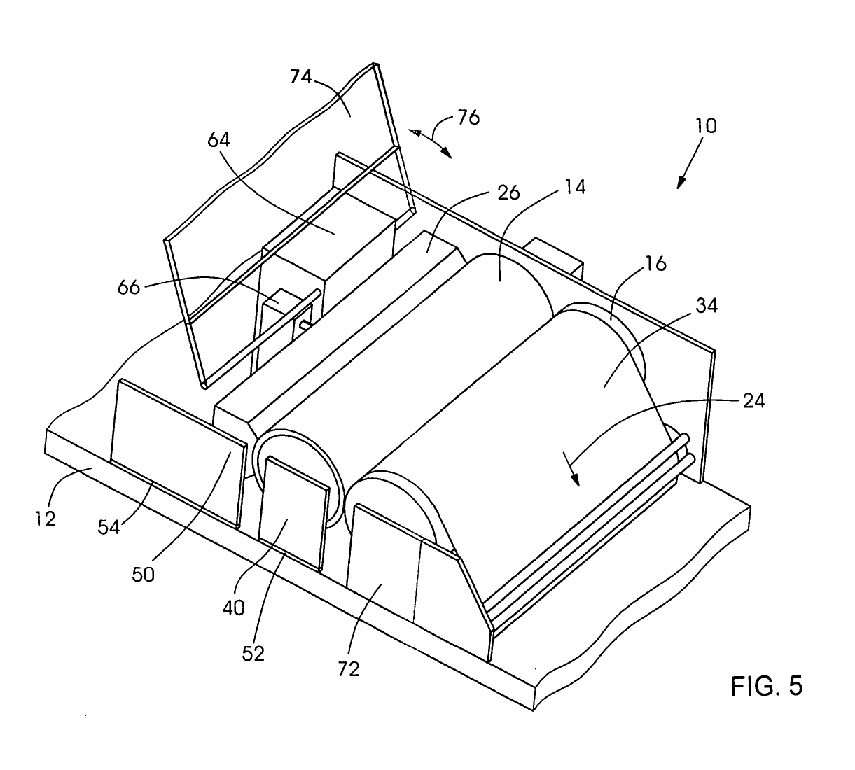

FIG. 5 is a view of one preferred embodiment of the gravure printing unit 10 according to the invention of a printing press 12, in particular of a combination printing press or a hybrid printing press. An gravure cylinder 14 interacts with a impression roller 16 for printing a printing material web 34 which is moved through the printing press in the direction 24. The gravure cylinder 14 is accommodated releasably on the printing press 12 via a first connecting element 48 (concealed in this drawing) by means of a bearing plate 40 of a first connecting platform 52, which bearing plate 40 can be folded away. A separate drive 68 of the printing press 12 is operatively connected to the gravure cylinder 14, in order to rotate the latter. A chamber-type ink doctor 26 is set against the gravure cylinder 14: a second connecting element 50 of the chamber-type ink doctor 26 is connected releasably to a second connecting platform 54 of the printing press. In an analogous manner to the embodiment in FIG. 3, the connecting platforms 52, 54 are designed to realize a relative movement, with the result that throwing-on and throwing-off operations can be carried out. The impression roller 16 is connected releasably to the printing press 12, independently of the gravure cylinder 14 and of the chamber-type ink doctor 26: the bearing plate 72 of the impression roller can be folded away, with the result that an accommodated impression roller 16 can be removed and another impression roller 16 can be inserted. In this way, impression rollers having different properties, such as different hardnesses or surface materials, can be used particularly advantageously, depending on the application. A impression roller 16 with a soft coating is preferably used for a relatively hard gravure cylinder 14. The throwing-on force or the throwing-on pressure of the chamber-type doctor 26 onto the gravure cylinder can be controlled or regulated by means of the control device 64 and a pneumatic throwing-on device which lies concealed in this view. A device 66 for oscillating the chamber-type doctor 26 is also provided. Finally, this embodiment of the gravure printing unit 10 also has a covering hood 74 which is configured so as to be pivotable in the direction 76, with the result that firstly the gravure printing unit 10 can be closed for operation and secondly can be opened for maintenance or changeover. It is implicitly obvious for the person skilled in the art, by way of the embodiments described, that, for a design of the gravure printing unit 10 for printing gravure printing ink which is cured by UV light, the gravure printing unit according to the invention has to be constructed from parts made from appropriately resistant materials, which are known in principle from the prior art, and/or the gravure printing form cylinder has to be engraved in an appropriately adapted manner.

This application claims the priority, under 35 U.S.C. § 119, of German patent application No. 10 2005 003 206.0, filed Jan. 24, 2005, and German patent application No. 10 2005 044 516.0, filed Sep. 16, 2005; the disclosures of the prior applications are herewith incorporated by reference in their entirety.

I claim:

1. A gravure printing unit assembly for printing a printing material web in a printing press, comprising:
a gravure cylinder, an ink applicator device, and an impression roller together disposed to form a functional gravure printing unit;
at least one connecting element for releasably mounting said gravure printing unit on a connecting platform of the printing press and forming a releasable operative connection with a separate drive for said gravure cylinder, wherein said gravure cylinder and said ink applicator device are separable from said connecting platform, while said impression roller remains in the printing press.

2. The gravure printing unit assembly according to claim 1, wherein the printing press has a defined course of travel for the material web, and said gravure cylinder and said ink applicator device are separable without altering the course of travel for the printing material web through the printing press and/or without severing the printing material web.

3. The gravure printing unit assembly according to claim 1, wherein the printing press has a first connecting platform and a second connecting platform and said connecting element is one of at least two connecting elements, with at least one first connecting element being configured for releasably mounting said gravure cylinder on the first connecting platform of the printing press, and at least one second connecting element for releasably mounting said ink applicator device on the second connecting platform of the printing press.

4. The gravure printing unit assembly according to claim 3, wherein the first connecting platforms and the second connecting platform are movably disposed relative to one another.

5. The gravure printing unit assembly according to claim 1, wherein the connecting platform is displaceably disposed in a substantially horizontal direction.

6. The gravure printing unit assembly according to claim 1, wherein said ink applicator device is a chamber-type ink doctor disposed to interact with said gravure cylinder.

7. The gravure printing unit assembly according to claim 6, which further comprises a pneumatic device forming a part of the gravure printing unit for throwing said chamber-type ink doctor onto said gravure cylinder.

8. The gravure printing unit assembly according to claim 6, which further comprises a movement device for laterally oscillating said chamber-type ink doctor.

9. The gravure printing unit assembly according to claim 1, which comprises a separate drive apparatus for directly driving said gravure cylinder.

10. The gravure printing unit assembly according to claim 9, wherein said separate drive apparatus is accommodated in the printing press and disposed to be releasably connected to said gravure cylinder.

11. The gravure printing unit assembly according to claim 1, wherein said gravure printing unit further comprises an anti-ghosting device.

12. The gravure printing unit assembly according to claim 1, which further comprises at least one heating element operatively associated with said ink applicator device and/or with said gravure cylinder, said heating element effecting temperature control for an ink to be printed.

13. The gravure printing unit assembly according to claim 1, wherein said impression roller is releasably mounted in the printing press.

14. The gravure printing unit assembly according to claim 1, wherein said gravure cylinder and said impression roller are disposed in the printing press with rotational axes thereof lying substantially in a horizontal plane.

15. The gravure printing unit assembly according to claim 1, wherein said gravure printing unit is configured for printing with UV-curable printing ink.

16. In combination with a printing press configured for printing a printing a printing material web and having an impression roller, a gravure printing unit module, comprising:
at least one gravure cylinder and an ink applicator device disposed to apply printing ink to said gravure cylinder;
said gravure cylinder and said ink applicator device, together and in interaction with the impression roller of the printing press forming a gravure printing unit.

17. The combination according to claim 16, which further comprises at least one connecting element for releasably mounting said gravure printing unit on a connecting platform of the printing press and forming a releasable operative connection with a separate drive for said gravure cylinder, wherein said gravure cylinder and said ink applicator device are separable from said connecting platform.

18. A printing press configured for printing a printing material web using a plurality of mutually different printing processes, comprising at least one gravure printing unit assembly according to claim 1.

19. The printing press according to claim 18, wherein said gravure printing unit includes at least one deflection roller disposed above said impression roller for reducing a wrap of the printing material web around said impression roller in comparison with an operation without said at least one deflection roller.
